(19) United States
(12) Patent Application Publication
(10) Pub. No.: US 2017/0275532 A1
(43) Pub. Date: Sep. 28, 2017

(54) FLUORESCENT MATERIAL, A MANUFACTURING METHOD THEREOF, AND A PHOTO-LUMINESCENT COMPOSITION CONTAINING THE FLUORESCENT MATERIAL

(71) Applicant: DALIAN LED LIGHTING R&D CENTER CO., LTD, Liaoning (CN)

(72) Inventors: YAOHUI CHANG, LIAONING (CN); ANATOLY B. VISHNYAKOV, LIAONING (CN); SHIMING LI, LIAONING (CN); CHANGKUI PAN, LIAONING (CN); LIN CHEN, LIAONING (CN)

(21) Appl. No.: 15/498,524

(22) Filed: Apr. 27, 2017

Related U.S. Application Data
(63) Continuation-in-part of application No. PCT/CN2015/000019, filed on Jan. 8, 2015.

(30) Foreign Application Priority Data
Oct. 29, 2014 (CN) 201410593556.6

(51) Int. Cl. C09K 11/77; C09K 11/08

(52) U.S. Cl. CPC C09K 11/7774; C09K 11/7734; C09K 11/0883

(57) ABSTRACT

A fluorescent material comprises a compound having the general formula of:

[Lu_{1-a-c-d-2/3b}YₐΣ(Ln−1)_{c}Σ(Ln−2)_{d}M_{b}]_{3±δ}[Al₁₋ₓGaₓ]₅(O_{1-1/2y}X_{y})_{12±1.5δ}.

The fluorescent material is combined with other compounds to form a photo-luminescent composition. The fluorescent material and the composition containing the same have a lot of advantages, such as high brightness, high color rendering index, high stability, and low light decay.

### CROSS-REFERENCE TO RELATED APPLICATIONS

This patent application is a continuation-in-part application, under 35 U.S.C. §120, of copending International Patent Application No. PCT/CN2015/000019, filed Jan. 8, 2015, which is in turn based upon and claims the benefit of the filing date, under 35 U.S.C. §119, of Chinese Patent Application No. 201410593556.6, filed Oct. 29, 2014, each of the prior patent applications being incorporated herein by reference in their entirety.

### FIELD OF THE INVENTION

The present invention relates to a fluorescent material and a manufacturing method thereof. The fluorescent material may be in combination with a plurality of matrix red-emitting phosphor powder to produce a photo-luminescent composition for white LED, mainly used in the field of illumination for white LED.

### BACKGROUND OF THE INVENTION

In the 1990s, the breakthrough in technology and industrialization of blue LED greatly promoted and realized the development of white light-emitting diodes (WLED).

In general, there have been three major categories of illumination source, such as incandescent bulbs, ordinary and compact fluorescent lamps, and high-pressure gas discharge lamps. A light-emitting diode (LED) is a new solid illumination source, wherein the semiconductor compound InGaN-based white LED has many advantages: high luminous efficiency, low heat, energy saving, stable performance, not easily damaged, long lifetime (up to 50,000 hours), environmental friendliness, no radiation, instant start, short response time, strong practicality, small bulk, compact structure, easy to implement large area arrays, etc.

The realization approach of white LED can be divided into the following three categories:

### (1) Tri-Phosphor LED Multi-Chip Combination:

The red, green, and blue tri-phosphor chips are assembled into a white LED. This method has the characteristics of high efficiency, controllable color temperature, and good color rendering index. As a result of the disadvantages of the unstable color temperature due to different light decay of tri-phosphor, complex electric circuit, and higher costs, the commercial practicability is not strong.

(2) Under n-UV (˜395 nm) Chip Excitation:

In recent years, with the development of semiconductor technology and manufacturing process, the luminous band of LED chips shifted to short wave. The current wavelength range of InGaN mainly covers the region from 350 nm to 420 nm (nUV-LED), and a shorter wavelength range (UV-LED 300-350 nm) has been reported, which enlarges the excitation wavelength range of phosphor powder matched with the chip. The red, green, and blue phosphor powders are excited by the high brightness near-ultraviolet LED and respectively produce the corresponding color of light then combined into white light, but there are still some difficulties in its current commercialization.

### (3) Under Blue (˜465 nm) LED Chip Excitation:

This white light system comprising the blue LED and yellow phosphor powder has the advantages of high efficiency, simple preparation, and good temperature stability, and it is the white LED system first to be studied and has been practical. The luminescence mechanisms for this system is that, when the forward DC voltage of 3˜5V is applied across the both ends of GaN/InGaN diode, some of the blue light (455˜475 nm) emitted from semiconductor chip excites the yttrium-aluminum garnet (Y—Al garnet) YAG:Ce³⁺ phosphor powder coated on the chip surface and activated by Ce³⁺ to make it emit yellow light (emission peak being at 555 nm). And then, the yellow light will blend with not absorbable blue light to create the white light. However, its drawback is the poor color rendering index caused by the lack of right light.

The white fluorescent efficiency depends on the matrix of the phosphor powder used, which may be silicates, sulfates, phosphates, oxides, aluminates, nitrides, and oxide-nitrides of phosphor powder or mixtures thereof. As compared with those above, under blue light excitation, the fluorescent material based on Y—Al garnet activated by Ce has the advantages of relatively high absorption efficiency, good thermal stability, high quantum efficiency, broad emission spectrum band, etc.

A yellow fluorescent material having a formula (Y₁₋ₓCeₓ)₃Al₅O₁₂ (abbr: YAG), i.e., a Y—Al garnet structure, is disclosed in U.S. Pat. No. 5,999,925 to Nichia Chemical Corporation. It can be combined with blue LED to generate white LED. This synthesized white LED has been applied in the field of white LED illumination in the commercial market, owing to the low cost and high luminous efficiency. However, its disadvantages are the poor color rendering index, the large influence of coating thickness on white light, and poor uniformity.

Kummer et al., U.S. Pat. No. 6,669,866, based on the above United States patent, replaces Y³⁺ with Tb³⁺ and proposes a fluorescent material having a formula (Tb_{1-x-y}ReₓCe_{y})₃(Al,Ga)₅O₁₂ (abbreviated TAG), known as Tb—Al garnet. However, because its luminous efficiency is still difficult to catch up with YAG fluorescent powder and the cost of terbium is quite expensive, the application of TAG phosphor powder is difficult.

A fluorescent material having a formula R_{(3-x-y)}M₅O₁₂:Ceₓ,R′_{y}, is disclosed in the patent CN: ZL02130949.3 by “Grirem Advanced Material Co. Ltd.”, wherein R is at least one element of Y, Gd, Lu, Sc, La, and Sm, M is at least one element of B, Al, Ga, In, P, Ge, and Zn, and R′ is at least one element of Tb, Eu, Dy, Pr, and Mn. Additionally, “Grirem Advanced Material Co. Ltd.” discloses further in the patent application CN: 1544575A using as a few divalent metal elements instead of aluminum or yttrium in white LED phosphor powder containing boron, by which in a certain extent luminous conversion efficiency and stability thereof are improved, thus the quantum efficiency and brightness thereof are also increased. Although the color rendering index of this phosphor powder has been improved compared with the foregoing YAG phosphor powder, the blue conversion efficiency and brightness are still low.

Ce acts as a luminescence activator in Y—Al garnet structure phosphor powder, and the energy level transitions of the atom thereof in matrix define the fluorescence color. The concentration of Ce decides the fluorescence brightness (the correlation function can also be achieved by praseodymium (Pr) and ytterbium (Yb)).

The elements Gd, Tb, La, Lu, and Sm acting as a sensitizer are responsible for shifting the wave peak of the fluorescence spectrum toward longer (Gd, Tb) or shorter (La, Lu, and Sm) waves.

### SUMMARY OF THE INVENTION

The object of the present invention is, in view of the shortcomings of the prior art, to provide a novel halogen co-activated aluminate which has the advantages of high brightness, high color rendering index, strong stability, low light decay, etc.

Based on the prior art references, the present invention shows that the halogen substitutes for oxygen form a charged center, and then the addition of charge compensators may substantially make the fluorescent material achieve charge balance. In the present case, it is called the charge compensation principle. A benefit to performing this compensation step is to increase the luminous intensity of the phosphor powder.

AlF₃, CaF₂, MgF₂, BaF₂, BaCl₂, SrF₂, and ZnCl₂ containing the co-activator halogen element F or Cl also act as a fluxing agent.

Owing to the introduction of the fluxing agent, the synthesis temperature of the fluorescent material in the present invention shows a decrease from 1600° C. down to about 1370° C., which is of great significance for reducing costs.

The halogen co-activated aluminate fluorescent material of the present invention has a wider spectral coverage (526 nm to 580 nm), a higher luminous intensity (enhanced about 15 percent), and lower cost than the commonly used traditional luminescent material. A white LED photo-luminescent composition having high luminous efficiency, high color rendering index (Ra can reach 87 or even higher), low color temperature, and high stability can be obtained by combining the fluorescent material in the present invention and the nitride red-emitting phosphor powder.

One aspect of the present invention provides a fluorescent material, characterized in that the fluorescent material comprises a compound having a general formula I:

[Lu_{1-a-c-d-2/3b}YₐΣ(Ln−1)_{c}Σ(Ln−2)_{d}M_{b}]_{3±δ}[Al₁₋ₓGaₓ]₅(O_{1-1/2y}X_{y})_{12±1.5δ} (I)

in which:

M is at least one element selected from the group consisting of Ca, Mg, Ba, Sr, and Zn;

b=0.5y(12±1.5δ), 0≦b≦0.2;

0.001≦a≦0.95;

0≦x≦0.5;

Σ(Ln−1) represents at least one element of La, Gd, Tb, Nd, and Ho, and 0≦c≦0.9;

Σ(Ln−2) represents an activator and is at least one element selected from the group consisting of Ce, Pr, Dy, Eu, Tm, Er, Sm, Yb, and Sc, and 0.001≦d≦0.5;

X represents a co-activator, which is at least one element selected from the group consisting of F and Cl, and 0.001≦y≦0.2;

1−a−c−d≧0; and

0<δ≦1.5.

One aspect of the present invention provides a fluorescent material, characterized in that the fluorescent material comprises a compound having a general formula I:

[Lu_{1-a-c-d-2/3b}YₐΣ(Ln−1)_{c}Σ(Ln−2)_{d}M_{b}]_{3εδ}[Al₁₋ₓGaₓ]₅(O_{1-1/2y}X_{y})_{12±1.5δ} (I)

in which

M is at least one element selected from the group consisting of Ca, Mg, Ba, Sr, and Zn;

(1−a−c−d−2/3b+a+c+d)(3±δ)≠3, 0≦b≦0.2;

0.001≦a≦0.95;

0≦x≦0.5;

Σ(Ln−1) represents at least one element of La, Gd, Tb, Nd, and Ho, and 0≦c≦0.9;

Σ(Ln−2) represents an activator and is at least one element selected from the group consisting of Ce, Pr, Dy, Eu, Tm, Er, Sm, Yb, and Sc, and 0.001≦d≦0.5;

X represents a co-activator, which is at least one element selected from the group consisting of F and Cl, and 0.001≦y≦0.2;

1−a−c−d≧0; and

0<δ≦1.5.

In some embodiments, the fluorescent material of the present invention comprises a compound having a general formula I-1:

[Lu_{1-a-c-d-2/3b}YₐΣ(Ln−1)_{c}Σ(Ln−2)_{d}M_{b}]_{3-δ}[Al₁₋ₓGaₓ]₅(O_{1-1/2}X_{y})_{12-1.5δ} (I- 1)

in which Σ(Ln−2) represents at least one element of Ce and Pr.

In some embodiments, the fluorescent material of the present invention comprises a compound having a general formula I-2:

[Lu_{1-a-c-d-2/3b}YₐΣ(Ln−1)_{c}Σ(Ln−2)_{d}M_{b}]_{3+δ}[Al₁₋ₓGaₓ]₅(O_{1-1/2y}X_{y})_{12+1.5δ} (I-2)

in which 0≦b<0.2.

In some embodiments, the fluorescent material of the present invention is selected from the group consisting of the following compounds:

[Lu_{0.4415}Y_{0.45}Ce_{0.05}Ba_{0.0585}]_{2.8}Al₅(O_{0.995},F_{0.01})_{11.7};

[Y_{0.7623}Gd_{0.17}Ce_{0.05}Ba_{0.01774}]_{2.884}Al₅(O_{0.9985},F_{0.003})_{11.826};

[Y_{0.6323}Gd_{0.29}Ce_{0.06}Ba_{0.01774}]_{2.884}Al₅(O_{0.9985},F_{0.003})_{11.826};

[Y_{0.3823}Gd_{0.55}Ce_{0.05}Ba_{0.01774}]_{2.884}Al₅(O_{0.9985},F_{0.003})_{11.826};

[Lu_{0.0995}Y_{0.7688}Gd_{0.07}Nd_{0.0005}Ce_{0.05}Ba_{0.01125}]_{2.5}(Al_{4.9}Ga_{0.1})(O_{0.999},F_{0.002})_{11.25}; and

[Lu_{0.0995}Y_{0.77}Gd_{0.07}Nd_{0.0005}Ce_{0.05}Ba_{0.01}]_{1.67}(Al_{4.9}Ga_{0.1})(O_{0.999},F_{0.002})_{10.005}.

In some embodiments, the fluorescent material of the present invention is selected from the group consisting of following compounds:

[Y_{0.8829}Gd_{0.005}Ce_{0.05}Ba_{0.0621}]_{3.28}Al₅(O_{0.995},F_{0.01})_{12.42};

[Lu_{0.4812}Y_{0.45}Ce_{0.05}Ba_{0.0188}]_{3.35}Al₅(O_{0.9985},F_{0.003})_{12.525};

[Lu_{0.5812}Y_{0.35}Ce_{0.05}Ba_{0.0188}]_{3.35}Al₅(O_{0.9985},F_{0.003})_{12.525};

[Lu_{0.7312}Y_{0.2}Ce_{0.05}Ba_{0.0188}]_{3.35}Al₅(O_{0.9985},F_{0.003})_{12.525};

[Y_{0.9262}Ce_{0.055}Ba_{0.0188}]_{3.35}Al_{4.5}Ga_{0.5}(O_{0.9985},F_{0.003})_{12.525};

[Y_{0.9262}Ce_{0.055}Ba_{0.0188}]_{3.35}Al_{4.0}Ga_{1.0}(O_{0.9985},F_{0.003})_{12.525};

[Y_{0.9262}Ce_{0.055}Ba_{0.0188}]_{3.35}Al_{3.5}Ga_{1.5}(O_{0.9985},F_{0.003})_{12.525};

[Y_{0.9262}Ce_{0.055}Ba_{0.0188}]_{3.35}Al_{3.0}Ga_{2.0}(O_{0.9985},F_{0.003})_{12.525}; and

[Y_{0.9262}Ce_{0.055}Ba_{0.0188}]_{3.35}Al_{2.79}Ga_{2.21}(O_{0.9985},F_{0.003})_{12.525}.

One aspect of the present invention provides a method for preparing the fluorescent material, comprising:

mixing yttrium oxide, cerium oxide, aluminium oxide or aluminium hydroxide, gadolinium oxide, gallium oxide, lutetium oxide, neodymium oxide, aluminum fluoride, barium fluoride uniformly to form a mixture, in which the amounts of yttrium oxide, cerium oxide, aluminium oxide or aluminium hydroxide, gadolinium oxide, gallium oxide, lutetium oxide, neodymium oxide are weighed according to the molar ratios of the metal elements of the phosphor according to the compounds set forth in the specification herein, while aluminium oxide or aluminium hydroxide is added in an amount in excess of 2 percent by weight, barium fluoride is added in an amount of from 2 to 4.5 percent by weight of all oxides, and aluminum fluoride is added in an amount of less than 1 percent; and

roasting the mixture at a temperature of 1330° C. to 1580° C. under a reducing atmosphere of a nitrogen-hydrogen mixed gas or a carbon reducing atmosphere for from 5 to 7 hours.

In some embodiments, said roasting is undertaken at a temperature of 1426° C. for 5 hours under a carbon reducing atmosphere.

One aspect of the present invention provides a photo-luminescent composition comprising:

the present invention fluorescent material; and

a red-emitting phosphor, such as a red-emitting phosphor powder, wherein the weight ratio of the fluorescent material and the red-emitting phosphor is from about 88%:12% to 92%:8%.

In some embodiments, the weight ratio of the fluorescent material and the red-emitting phosphor is about 90%:10%.

In some embodiments, said red-emitting phosphor is selected from the group consisting of nitrides and silicates.

In some embodiments, the red-emitting phosphor is a nitride having a general formula of SrAlSiN₃:Eu²⁺.

In some embodiments, the red-emitting phosphor is a silicate having a general formula of (Sr,Ba)_{1.88}SiO₄:Eu²⁺.

In some embodiments, the fluorescent material of the present invention is [Lu_{0.4415}Y_{0.45}Ce_{0.05}Ba_{0.0585}]_{2.8}Al₅(O_{0.995},F_{0.01})_{11.7}.

In some embodiments, the fluorescent material of the present invention comprises a compound having a general formula I-1-1:

[Yₐ,Gd_{c},Σ(Ln−2)_{d}M_{b}]_{2.884}(Al₁₋ₓGaₓ)₅(O_{1-1/2y}X_{y})_{11.826} (I-1-1).

In some embodiments, the fluorescent material of the present invention comprises a compound having a general formula I-2:

[Lu_{1-a-c-d-2/3b}YₐΣ(Ln−1)_{c}Σ(Ln−2)_{d}M_{b}]_{3+δ}[Al₁₋ₓGaₓ]₅(O_{1-1/2y}X_{y})_{12+1.5δ} (I-2)

in which 3<3+δ≦4.5, 0.001≦a≦0.95, 0≦b≦0.2, 0≦x≦0.5;

Σ(Ln−1) represents at least one element of La, Gd, Tb, Nd, and Ho, and 0≦c≦0.9;

Σ(Ln−2) represents at least one element of Ce, Pr, Dy, Eu, Tm, Er, Sm, Yb, and Sc, and 0.001≦d≦0.5; and

X represents at least one element selected from F and Cl, and 0.001≦y≦0.2.

In some embodiments, the fluorescent material of the present invention comprises a compound having a general formula I-2-1:

[Lu_{1-a-c-d-2/3b}YₐΣ(Ln−1)_{c}Σ(Ln−2)_{d}M_{b}]_{3.35}[Al₁₋ₓGaₓ]₅(O_{1-1/2y}X_{y})_{12.525} (I-2-1).

In some embodiments, the fluorescent material for use in white LED in the present invention offers an luminescent characteristic of the Ce activator, which forms a broad emission band at a yellow-green zone peak of 525 nm to 583 nm.

In some embodiments, the fluorescent material for use in white LED in the present invention offers a luminescent characteristic that the emission peak will be blue-shift as the varying of the ratio between Al and Ga.

In some embodiments, the fluorescent material for use in white LED in the present invention offers a characteristic that it can be excited by a UV to blue light with wavelengths ranging from 250 nm to 490 nm.

In some embodiments, the fluorescent material for use in white LED in the present invention offers a characteristic, which emits a visible area ranging from 450 nm to 700 nm, as well as the peak is located at 525 nm to 610 nm.

Obviously, according to the general formula proposed by the present invention, the value of (3±δ) varies in the range between 1.5 and 4.5, both inclusive, which is not equal to 3. Therefore, it goes beyond the known classic YAl garnet fluorescent powder patent solution belonging to non-stoichiometric compounds.

The present invention provides a method for preparing a fluorescent material for a white LED, the method comprising the steps of:

(1) providing the starting materials comprising oxides of Y₂O₃, CeO₂, Ln−1, oxides of Ln−2, and Ga₂O₃, Al₂O₃, AlF₃, and BaF₂, which are weighed according to the molar ratios specified in the formula:

[Lu_{1-a-c-d-2/3b}YₐΣ(Ln−1)_{c}Σ(Ln−2)_{d}M_{b}]_{3±δ}[Al₁₋ₓGaₓ]₅(O_{1-1/2y}X_{y})_{12±1.5δ};

(2) ball milling and mixing uniformly the starting materials mixed in (1) under dry conditions;

(3) roasting the materials mixed uniformly at a temperature of 1330° C. to 1580° C. under a reducing atmosphere for 5 to 7 hours and cooling to obtain a compound comprising (I-1) and (I-2):

[Lu_{1-a-c-d-2/3b}YₐΣ(Ln−1)_{c}Σ(Ln−2)_{d}M_{b}]_{3-δ}[Al₁₋ₓGaₓ]₅(O_{1-1/2y}X_{y})_{12-1.5δ},

[Lu_{1-a-c-d-2/3b}YₐΣ(Ln−1)_{c}Σ(Ln−2)_{d}M_{b}]_{3+δ}[Al₁₋ₓGaₓ]₅(O_{1-1/2y}X_{y})_{12+1.5δ};

(4) the roasted compound in (3) is ground in a mortar and subjected to a series of post-treatment steps by caustic wash, acid pickling, washing, and alcohol washing to complete the coating; and

(5) drying the product washed in (4) at 140° C. for 16 hours to obtain a phosphor powder having high luminous efficiency, high color rendering index, strong stability, and low light decay.

As described above, the phosphor powder synthesized in the present invention concentrates on the compounds of (Lu+Y+Ln)_{3±δ}Al₅O_{12±1.5δ} type, wherein the corresponding ratio of

$$\frac{Lu + Y + Ln}{A 1}$$

varies from 0.3 to 0.9 when the stoichiometric index (3±δ) varies from 1.5 to 4.5, and unlike the index ratio Y/Al of the conventional Y₃Al₅O₁₂ compounds being fixed to 0.6, there is a broader range for the index ratio in this present invention.

As is known, alumina and rare earth oxides can form a variety of compounds. For example, in the Y₂O₃—AlO₃ system, in addition to Y₃Al₅O₁₂, a series of compounds can be formed, and the following series can be formed according to the change in Y—Al content: Y₅Al₃O₁₂—YAlO₃—Y₃Al₅O₁₂—YAl₂O_{4.5}—YAl₃O₆ [Joint Committee on Powder Diffraction Standards: JCPDS Data Base].

The above series may transform into the following forms Y_{7.5}Al₅O₁₈—Y₅Al₅O₁₅—Y₃Al₅O₁₂—Y_{2.5}Al₅O_{11.25}—Y_{1.67}Al₅O₁₀ when the content of Al is a constant value in the molecular formula. On the basis of these compounds, yttrium and aluminum may be replaced by other rare earth elements and Ga, respectively, and the yttrium-doped compound can be synthesized, i.e., the compound of the present invention: [Lu_{1-a-c-d-2/3b}YₐΣ(Ln−1)_{c}Σ(Ln−2)_{d}M_{b}]_{3±δ}[Al₁₋ₓGaₓ]₅(O_{1-1/2y}X_{y})_{12±1.5δ}.

As far as the inventors know, this type of compound and the proportions thereof have not been demonstrated by others, and the practical application thereof has not been published in the patent literature.

As described above, the fluorescent material for white LED according to the present invention can be excited by a purple light of 250 nm to blue light of 490 nm, or can be combined with any one of a red-emitting phosphor powder of a sulfide, a nitride, and a silicate matrix to form white LED.

The red nitride phosphor powder used in the above white LED can be represented by: SrAlSiN₃:Eu²⁺.

The red silicate phosphor powder used in the above white LED can be represented by: (Sr,Ba)_{1.88}SiO₄:Eu²⁺.

Other features which are considered as characteristic for the invention are set forth in the appended claims.

Although the invention is illustrated and described herein regarding fluorescent material, a manufacturing method thereof, and a photo-luminescent material containing the fluorescent material, it is nevertheless not intended to be limited to the details shown herein, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A and FIG. 1B show XRD spectra, respectively, of the Y₃Al₅O₁₂ standard powder diffraction card and the fluorescent material having a formula: [Y_{0.7623}Gd_{0.17}Ce_{0.05}Ba_{0.01774}]_{2.884}Al₅(O_{0.9985},F_{0.003})_{11.826}.

FIG. 2 shows the excitation and emission spectra of the fluorescent material having a formula [Lu_{0.4415}Y_{0.45}Ce_{0.05}Ba_{0.0585}]_{2.8}Al₅(O_{0.995},F_{0.01})_{11.7} and silicate-based green phosphor powder with a formula YSrBaSiO₅:Eu²⁺, respectively, under monitoring of 555 nm and excitation of 460 nm blue LED.

FIG. 3 shows the emission spectrum of the fluorescent material having a formula [Y_{0.8829}Gd_{0.005}Ce_{0.05}Ba_{0.0621}]_{3.28}Al₅(O_{0.995},F_{0.01})_{12.42} excited at 460 nm blue LED.

FIG. 4 shows the emission spectra of fluorescent materials with different ratios of Y to Lu excited by 460 nm blue LED. The molecular formulas of the fluorescent materials are, respectively:

[Lu_{0.4812}Y_{0.45}Ce_{0.05}Ba_{0.0188}]_{3.35}Al₅(O_{0.9985},F_{0.003})_{12.5257}

[Lu_{0.5812}Y_{0.35}Ce_{0.05}Ba_{0.0188}]_{3.35}Al₅(O_{0.9985},F_{0.003})_{12.525}, and

[Lu_{0.7312}Y_{0.2}Ce_{0.05}Ba_{0.0188}]_{3.35}Al₅(O_{0.9985},F_{0.003})_{12.525}.

FIG. 5 shows the excitation spectra of fluorescent materials with different ratios of Y to Gd at 564 nm, 572 nm, and 578 nm, respectively;

FIG. 6 shows the emission spectra of fluorescent materials with different ratios of Y to Gd excited by 460 nm blue LED. The molecular formulas of the fluorescent materials are, respectively:

[Y_{0.7623}Gd_{0.17}Ce_{0.05}Ba_{0.01774}]_{2.884}Al₅(O_{0.9985},F_{0.003})_{11.8267}

[Y_{0.6323}Gd_{0.29}Ce_{0.06}Ba_{0.01774}]_{2.884}Al₅(O_{0.9985},F_{0.003})_{11.826}, and

[Y_{0.3823}Gd_{0.55}Ce_{0.05}Ba_{0.01774}]_{2.884}Al₅(O_{0.9985},F_{0.003})_{11.826}.

FIG. 7 shows the emission spectra of fluorescent materials with different ratios of (3−δ) excited by 460 nm blue LED. The molecular formulas of the fluorescent materials are, respectively:

[Lu_{0.0995}Y_{0.7688}Gd_{0.07}Nd_{0.0005}Ce_{0.05}Ba_{0.01125}]_{2.5}(Al_{4.9}Ga_{0.1})(O_{0.999},F_{0.002})_{11.257}

[Lu_{0.0995}Y_{0.77}Gd_{0.07}Nd_{0.0005}Ce_{0.05}Ba_{0.01}]_{1.67}(Al_{4.9}Ga_{0.1})(O_{0.999},F_{0.002})_{10.005}.

FIG. 8 shows the emission spectra of fluorescent materials with different ratios of Al to Ga excited by 460 nm blue LED. The molecular formulas of the fluorescent materials are, respectively:

[Y_{0.9262}Ce_{0.055}Ba_{0.0188}]_{3.35}Al_{4.5}Ga_{0.5}(O_{0.9985},F_{0.003})_{12.525},

[Y_{0.9262}Ce_{0.055}Ba_{0.0188}]_{3.35}Al_{4.0}Ga_{1.0}(O_{0.9985},F_{0.003})_{12.525},

[Y_{0.9262}Ce_{0.055}Ba_{0.0188}]_{3.35}Al_{3.5}Ga_{1.5}(O_{0.9985},F_{0.003})_{12.525},

[Y_{0.9262}Ce_{0.055}Ba_{0.0188}]_{3.35}Al_{3.0}Ga_{2.0}(O_{0.9985},F_{0.003})_{12.525}, and

[Y_{0.9262}Ce_{0.055}Ba_{0.0188}]_{3.35}Al_{2.79}Ga_{2.21}(O_{0.9985},F_{0.003})_{12.525}.

FIG. 9 shows the spectra for white LED photo-luminescent compositions tested on a blue light diode-based solid white light source, and the compositions are formed by the fluorescent material having the formula (Lu_{0.4415}Y_{0.45}Ce_{0.05}Ba_{0.0585})_{2.8}Al₅(O_{0.995},F_{0.01})_{11.7} with a red-emitting phosphor powder SrAlSiN₃:Eu²⁺ and (Sr,Ba)_{1.88}SiO₄:Eu²⁺, and by Y₃Al₅O₁₂:Ce³⁺ and SrAlSiN₃:Eu²⁺, respectively.

### DETAILED DESCRIPTION OF THE INVENTION

The phosphor powder prepared has the molecular formula:

[Lu_{1-a-c-d-2/3b}YₐΣ(Ln−1)_{c}Σ(Ln−2)_{d}M_{b}]_{3-δ}[Al₁₋ₓGaₓ]₅(O_{1-1/2y}X_{y})_{12-1.5δ}

[Lu_{1-a-c-d-2/3b}YₐΣ(Ln−1)_{c}Σ(Ln−2)_{d}M_{b}]_{3+δ}[Al₁₋ₓGaₓ]₅(O_{1-1/2y}X_{y})_{12+1.5δ}

According to the difference between the stoichiometric index (3±δ) and (12±1.5δ), 15 samples are synthesized using different ratios of rare earth elements and doped aluminum.

As specific examples, data is provided for 15 samples, and the optical properties thereof exhibit a regular change.

The phosphor powder samples shown in the embodiment are prepared by roasting the mixture of Y₂O₃, rare-earth metals oxides, and Al₂O₃ at a high temperature. And the particle size (D50) of the starting material used is less than 3 microns (measured by a laser particle size analyzer).

### PREPARATION EXAMPLES

There are many ways to synthesize aluminate as a green-emitting phosphor powder, such as high temperature solid phase method, co-precipitation method, sol-gel method, etc.

In the present invention, a fluorescent material is prepared by a high temperature solid phase method.

### Required Raw Materials:

(a) Y₂O₃—(5N)
(b) Gd₂O₃—(4N)
(c) Al₂O₃—(4N)
(d) CeO₂—(4N)
(e) Ga₂O₃—(4N)
(f) Lu₂O₃—(4N)
(g) Nd₂O₃—(4N)
(h) AlF₃—(4N)
(i) BaF₂—(4N)

Raw materials (yttrium oxide, lanthanide rare earth metal oxides and alumina) dry powder are vibrated and mixed evenly in sealed plastic containers.

The mixture is added with a compound containing a co-activator halogen element and capable of acting as a fluxing agent (e.g., barium fluoride and aluminum fluoride) during the calcination preparation. Its role as a fluxing agent is to form a liquid phase in the solid surface reaction, thereby speeding up the mass transfer rate and the generation speed of the target product. The doping amount of barium fluoride is 2% to 4.5% by weight of the oxide, and the doping amount of the aluminum fluoride is less than 1%.

After the materials above are ground well, they are loaded into a high purity alumina (Al₂O₃) crucible, gradually heated in a hydrogen-hydrogen reduction (V_{N2}/V_{H2}=3/1) atmosphere or a carbon reducing atmosphere, and roasted at a temperature of 1330° C. to 1580° C. for from 5 to 7 hours and then removed from the furnace when cooled to below 500° C.

Pickling with concentrated nitric acid, then washing with potassium pyrophosphate, washing with water several times to neutral, adding 0.1% lanthanum nitrate, neutralizing with ammonia, filtering, drying in an oven at 140° C. for several hours, washing with isopropyl alcohol, adding 5‰ ethyl orthosilicate, and coating the surface of the powder with a layer of silicon film, results in the production of loose smooth powder, i.e., the fluorescent material of the present invention.

The fluorescent materials obtained by the above method are excited by 460 nm blue light, and the emission peak is located at 537 nm to 578 nm green band.

### Example 1

Proportional amounts of the starting materials are used to meet the stoichiometric requirements of the formula:

[Lu_{0.4415}Y_{0.45}Ce_{0.05}Ba_{0.0585}]_{2.8}Al₅(O_{0.995},F_{0.01})_{11.7}.

The starting materials Y₂O₃, Lu₂O₃, CeO₂, Al₂O₃, AlF₃, and BaF₂ are roasted under a nitrogen-hydrogen reducing atmosphere (V_{N2}/V_{H2}=3/1) at a temperature of 1337° C. for 5 hours.

The excitation (under the monitoring of 555 nm) and emission (under excitation of 460 nm blue LED) spectra of this fluorescent material having a molecular formula:

[Lu_{0.4415}Y_{0.45}Ce_{0.05}Ba_{0.0585}]_{2.8}Al₅(O_{0.9957},F_{0.01})_{11.7}

are shown in FIG. 2.

### Example 2

Proportional amounts of the starting materials are used to meet the stoichiometric requirements of the formula:

[Y_{0.8829}Gd_{0.005}Ce_{0.05}Ba_{0.0621}]_{3.28}Al₅(O_{0.995},F_{0.01})_{12.42}.

The starting materials Y₂O₃, Gd₂O₃, CeO₂, Al₂O₃, AlF₃ and BaF₂ are roasted under a carbon reducing atmosphere at a temperature of 1377° C. for 7 hours.

The emission (under excitation of 460 nm blue LED) spectrum of this fluorescent material having a molecular formula:

[Y_{0.8829}Gd_{0.005}Ce_{0.05}Ba_{0.0621}]_{3.28}Al₅(O_{0.995},F_{0.01})_{12.42}

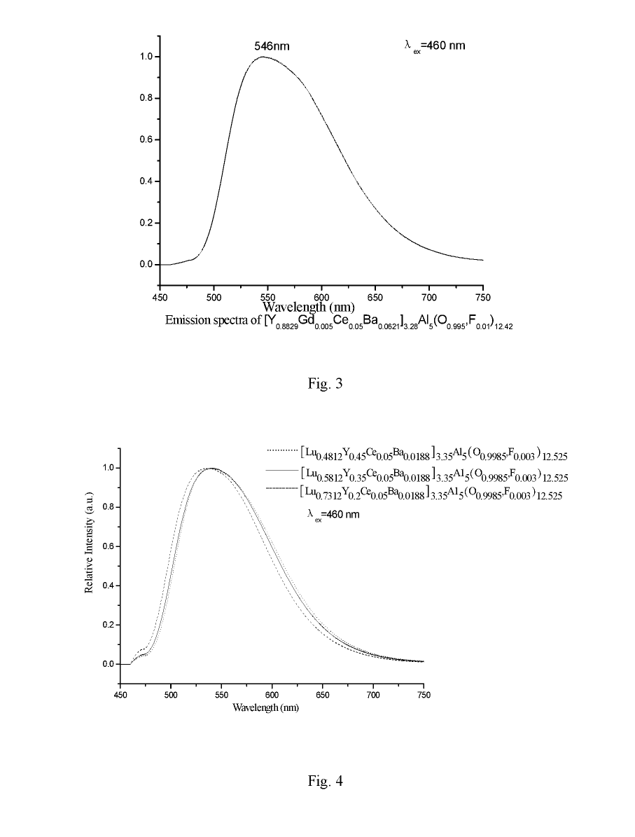

is shown in FIG. 3.

### Example 3

Preparation of fluorescent materials having different ratios of Y to Lu: Proportional amounts of the starting materials are used to meet the stoichiometric requirements of the respective formulas:

[Lu_{0.4812}Y_{0.45}Ce_{0.05}Ba_{0.0188}]_{3.35}Al₅(O_{0.9985},F_{0.003})_{12.5257}

[Lu_{0.5812}Y_{0.35}Ce_{0.05}Ba_{0.0188}]_{3.35}Al₅(O_{0.9985},F_{0.003})_{12.525}, and

[Lu_{0.7312}Y_{0.2}Ce_{0.05}Ba_{0.0188}]_{3.35}Al₅(O_{0.99857},F_{0.003})_{12.525}.

The starting materials Y₂O₃,Lu₂O₃,CeO₂,Al₂O₃,AlF₃ and BaF₂ are roasted under a nitrogen-hydrogen reducing atmosphere (V_{N2}/V_{H2}=3/1) at a temperature of 1512° C. for 5 hours.

The molecular formulas of the fluorescent materials with different ratios of Y to Lu are, respectively:

[Lu_{0.4812}Y_{0.45}Ce_{0.05}Ba_{0.0188}]_{3.35}Al₅(O_{0.9985},F_{0.003})_{12.5257}

[Lu_{0.5812}Y_{0.35}Ce_{0.05}Ba_{0.0188}]_{3.35}Al₅(O_{0.9985},F_{0.003})_{12.525}, and

[Lu_{0.7312}Y_{0.2}Ce_{0.05}Ba_{0.0188}]_{3.35}AlO_{0.9985},F_{0.003})_{12.525}.

The emission spectrum (under excitation of 460 nm blue LED) of the above fluorescent materials is shown in FIG. 4.

### Example 4

Preparation of fluorescent materials having different ratios of Y to Gd: Proportional amounts of the starting materials are used to meet the stoichiometric requirements of the respective formulas:

[Y_{0.7623}Gd_{0.17}Ce_{0.05}Ba_{0.01774}]_{2.884}Al₅(O_{0.9985},F_{0.003})_{11.8267}

[Y_{0.6323}Gd_{0.29}Ce_{0.06}Ba_{0.01774}]_{2.884}Al₅(O_{0.9985},F_{0.003})_{11.826}, and

[Y_{0.3823}Gd_{0.55}Ce_{0.05}Ba_{0.01774}]_{2.884}Al₅(O_{0.9985},F_{0.003})_{11.826}

The starting materials Y₂O₃,Gd₂O₃,CeO₂,Al₂O₃,AlF₃ and BaF₂ are roasted under a carbon reducing atmosphere at a temperature of 1377° C. for 7 hours.

The molecular formulas of the fluorescent materials with different ratios of Y to Lu are, respectively:

[Y_{0.7623}Gd_{0.17}Ce_{0.05}Ba_{0.01774}]_{2.884}Al₅(O_{0.9985},F_{0.003})_{11.826},

[Y_{0.6323}Gd_{0.29}Ce_{0.06}Ba_{0.01774}]_{2.884}Al₅(O_{0.9985},F_{0.003})_{11.826}, and

[Y_{0.3823}Gd_{0.55}Ce_{0.05}Ba_{0.01774}]_{2.884}Al₅(O_{0.9985},F_{0.003})_{11.826}.

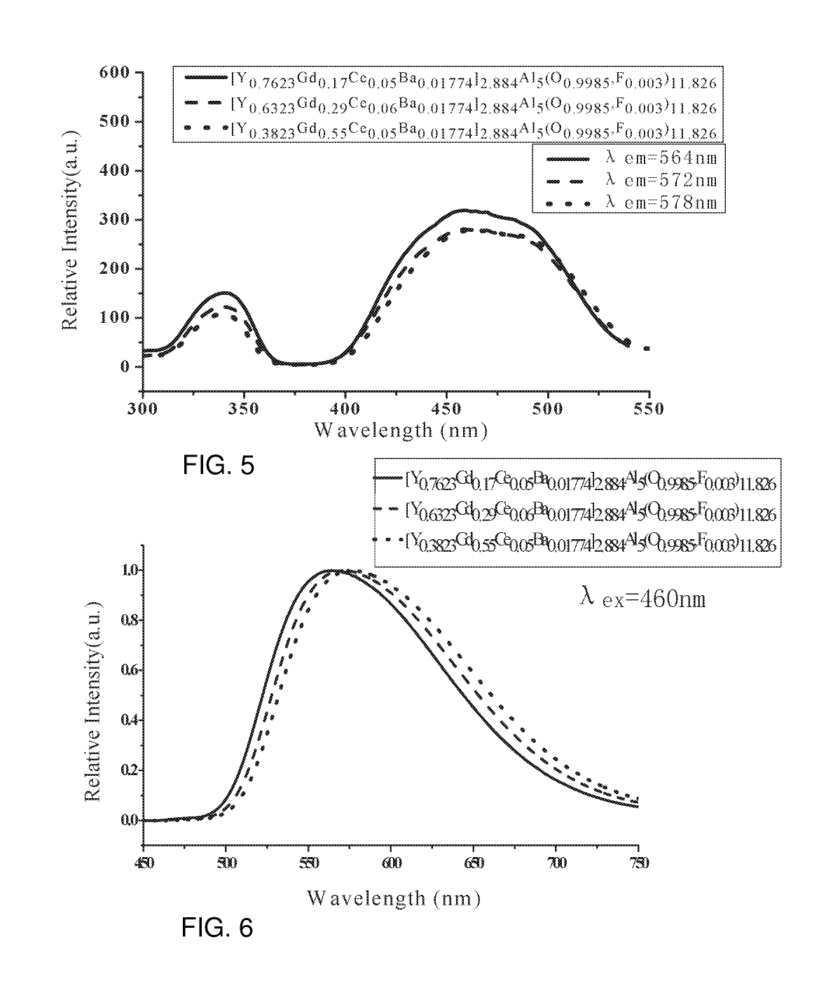

The excitation spectrum (under monitoring of 564 nm, 572 nm and 578 nm, respectively) of the above fluorescent materials is shown in FIG. 5. The emission spectrum (under excitation of 460 nm blue LED) is shown in FIG. 6.

### Example 5

Proportional amounts of the starting materials are used to meet the stoichiometric requirements of the formula:

[Lu_{0.0995}Y_{0.7688}Gd_{0.07}Nd_{0.0005}Ce_{0.05}Ba_{0.01125}]_{2.5}(Al_{4.9}Ga_{0.1})(O_{0.999},F_{0.002})_{11.25}

The starting materials Y₂O₃, Lu₂O₃,Gd₂O₃,CeO₂,Nd₂O₃,Al₂O₃,Ga₂O₃,AlF₃ and BaF₂, are roasted under a nitrogen-hydrogen reducing atmosphere (V_{N2}/V_{H2}=3/1) at a temperature of 1550° C. for 5 hours.

### Example 6

Proportional amounts of the starting materials are used to meet the stoichiometric requirements of the formula:

[Lu_{0.0995}Y_{0.77}Gd_{0.07}Nd_{0.0005}Ce_{0.05}Ba_{0.01}]_{1.67}(Al_{4.9}Ga_{0.1})(O_{0.999},F_{0.002})_{10.005}.

The starting materials and thermal conditions are the same with example 5.

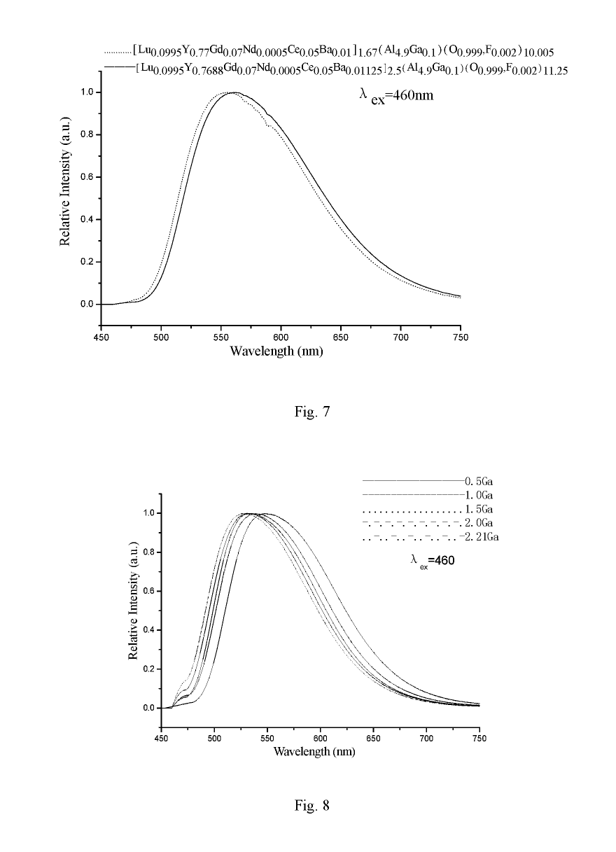

The emission spectrum (under excitation of 460 nm blue LED) of the fluorescent materials having different ratios of (3−δ) is shown in FIG. 7. The molecular formulas are, respectively:

[Lu_{0.0995}Y_{0.7688}Gd_{0.07}Nd_{0.0005}Ce_{0.05}Ba_{0.01125}]_{2.5}(Al_{4.9}Ga_{0.1})(O_{0.999},F_{0.002})_{11.25},

[Lu_{0.0995}Y_{0.77}Gd_{0.07}Nd_{0.0005}Ce_{0.05}Ba_{0.01}]_{1.67}(Al_{4.9}Ga_{0.1})(O_{0.999},F_{0.002})_{10.005}.

### Example 7

Preparation of fluorescent materials having different ratios of Al to Ga: Proportional amounts of the starting materials are used to meet the stoichiometric requirements of the respective formulas:

[Y_{0.9262}Ce_{0.055}Ba_{0.0188}]_{3.35}Al_{4.5}Ga_{0.5}(O_{0.9985},F_{0.003})_{12.525},

[Y_{0.9262}Ce_{0.055}Ba_{0.0188}]_{3.35}Al_{4.0}Ga_{1.0}(O_{0.9985},F_{0.003})_{12.525},

[Y_{0.9262}Ce_{0.055}Ba_{0.0188}]_{3.35}Al_{3.5}Ga_{1.5}(O_{0.9985},F_{0.003})_{12.525},

[Y_{0.9262}Ce_{0.055}Ba_{0.0188}]_{3.35}Al_{3.0}Ga_{2.0}(O_{0.9985},F_{0.003})_{12.525}, and

[Y_{0.9262}Ce_{0.055}Ba_{0.0188}]_{3.35}Al_{2.79}Ga_{2.21}(O_{0.9985},F_{0.003})_{12.525}.

The starting materials Y₂O₃, CeO₂, Al₂O₃, Ga₂O₃, AlF₃, and BaF₂ are roasted under a carbon reducing atmosphere at a temperature of 1426° C. for 5 hours.

The molecular formulas of the fluorescent materials with different ratios of Al to Ga are, respectively:

[Y_{0.9262}Ce_{0.055}Ba_{0.0188}]_{3.35}Al_{4.5}Ga_{0.5}(O_{0.9985},F_{0.003})_{12.525},

[Y_{0.9262}Ce_{0.055}Ba_{0.0188}]_{3.35}Al_{4.0}Ga_{1.0}(O_{0.9985},F_{0.003})_{12.525},

[Y_{0.9262}Ce_{0.055}Ba_{0.0188}]_{3.35}Al_{3.5}Ga_{1.5}(O_{0.9985},F_{0.003})_{12.525},

[Y_{0.9262}Ce_{0.055}Ba_{0.0188}]_{3.35}Al_{3.0}Ga_{2.0}(O_{0.9985},F_{0.003})_{12.525}, and

[Y_{0.9262}Ce_{0.055}Ba_{0.0188}]_{3.35}Al_{2.79}Ga_{2.21}(O_{0.9985},F_{0.003})_{12.525}.

The emission spectrum (under excitation of 460 nm blue LED) of the above fluorescent materials is shown in FIG. 8.

### Example 8

A white LED photo-luminescent composition is prepared by the combination of fluorescent material [Lu_{0.4415}Y_{0.45}Ce_{0.05}Ba_{0.0585}]_{2.8}Al₅(O_{0.995}, F_{0.01})_{11.7} prepared in example 1 and nitride red-emitting phosphor powder SrAlSiN₃:Eu²⁺.

### Example 9

A white LED photo-luminescent composition is prepared by combination of the fluorescent material [Lu_{0.4415}Y_{0.45}Ce_{0.05}Ba_{0.0585}]_{2.8}Al₅(O_{0.995},F_{0.01})_{11.7} prepared in example 1 and the silicate red-emitting phosphor powder (Sr,Ba)_{1.88}SiO₄:Eu²⁺.

### Example 10

A white LED photo-luminescent composition is prepared by combination of fluorescent material Y₃Al₅O₁₂:Ce³⁺ and nitride red-emitting phosphor powder SrAlSiN₃:Eu²⁺.

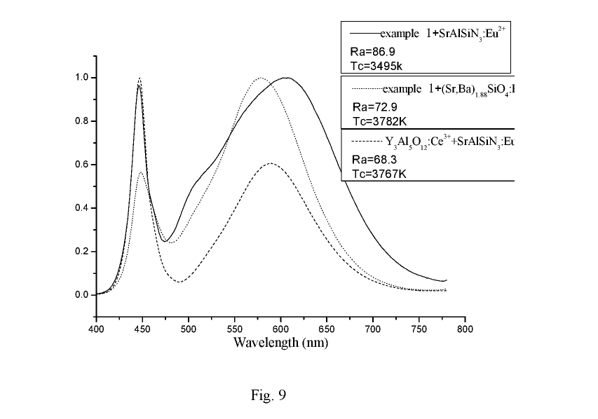

The photo-luminescent composition formed by the fluorescent material prepared in example 1 with the formula [Lu_{0.4415}Y_{0.45}Ce_{0.05}Ba_{0.0585}]_{2.8}Al₅(O_{0.995},F_{0.01})_{11.7} respectively is combined with the red-emitting phosphor powder with a formula SrAlSiN₃:Eu²⁺ or (Sr,Ba)_{1.88}SiO₄:Eu²⁺, as well as the white LED photo-luminescent composition formed by Y₃Al₅O₁₂:Ce³⁺ in combination with SrAlSiN₃:Eu²⁺, which are tested in a blue light diode-based solid white light source and the spectra thereof are shown in FIG. 9.

Optical property parameters of the samples in the examples are measured, using a HAAS-2000 spectroradiometer, available from Everfine Photo-E-Info Co., Ltd. The yellow-orange fluorescence spectra reflected by samples and radiated by the composite blue light (455 nm) diode are measured, with the angle of reflection of 45° and the wavelength range from 380 nm to 780 nm. The optical characteristics of the fluorescent materials of Examples 1 to 7 are shown in Table 1 below, wherein the sample numbers correspond to the example numbers:

TABLE 1

| | | I, | Peak | Main | Colour | | Color |
|---|---|---|---|---|---|---|---|
| Nos. of | | Integrated | wavelength | wavelength | Coordinates | | temperature |
| samples | 3 ± δ | brightness | (λpeak, nm) | (λdom, nm) | x | y | (Tc, K) |
| 1 | 2.8 (a = 0.45) | 103.99 | 556 | 569.8 | 0.4352 | 0.5414 | 3856 |
| 2 | 3.28 (a = 0.8829) | 110.36 | 546 | 568.6 | 0.4270 | 0.5489 | 4002 |
| 3 | 3.35 (a = 0.45) | 107.9 | 543 | 565 | 0.4001 | 0.5603 | 4432 |
| | 3.35 (a = 0.35) | 114.69 | 539 | 564.1 | 0.3935 | 0.5627 | 4539 |
| | 3.35 (a = 0.2) | 113.09 | 537 | 561.4 | 0.3747 | 0.5676 | 4838 |
| 4 | 2.884 (a = 0.7623) | 93.46 | 564 | 574.7 | 0.4721 | 0.5155 | 3231 |
| | 2.884 (a = 0.6323) | 87.16 | 572 | 577.2 | 0.4896 | 0.5014 | 2934 |
| | 2.884 (a = 0.3823) | 80.35 | 578 | 579 | 0.5030 | 0.4902 | 2714 |
| 5 | 2.5 (a = 0.7688) | 95.83 | 562 | 573 | 0.4596 | 0.525 | 3444 |
| 6 | 1.67 (a = 0.77) | 77.83 | 555 | 571.1 | 0.445 | 0.5348 | 3689 |
| 7 | 3.35 (x = 0.5) | 101.66 | 549 | 568.9 | 0.429 | 0.5451 | 3959 |
| | 3.35 (x = 1.0) | 106.42 | 540 | 564.4 | 0.3951 | 0.5592 | 4505 |
| | 3.35 (x = 1.5) | 111.46 | 535 | 562.4 | 0.3816 | 0.5672 | 4730 |
| | 3.35 (x = 2.0) | 111.58 | 531 | 560.5 | 0.3685 | 0.5662 | 4932 |
| | 3.35 (x = 2.21) | 102.22 | 526 | 558.4 | 0.3551 | 0.5651 | 5149 |

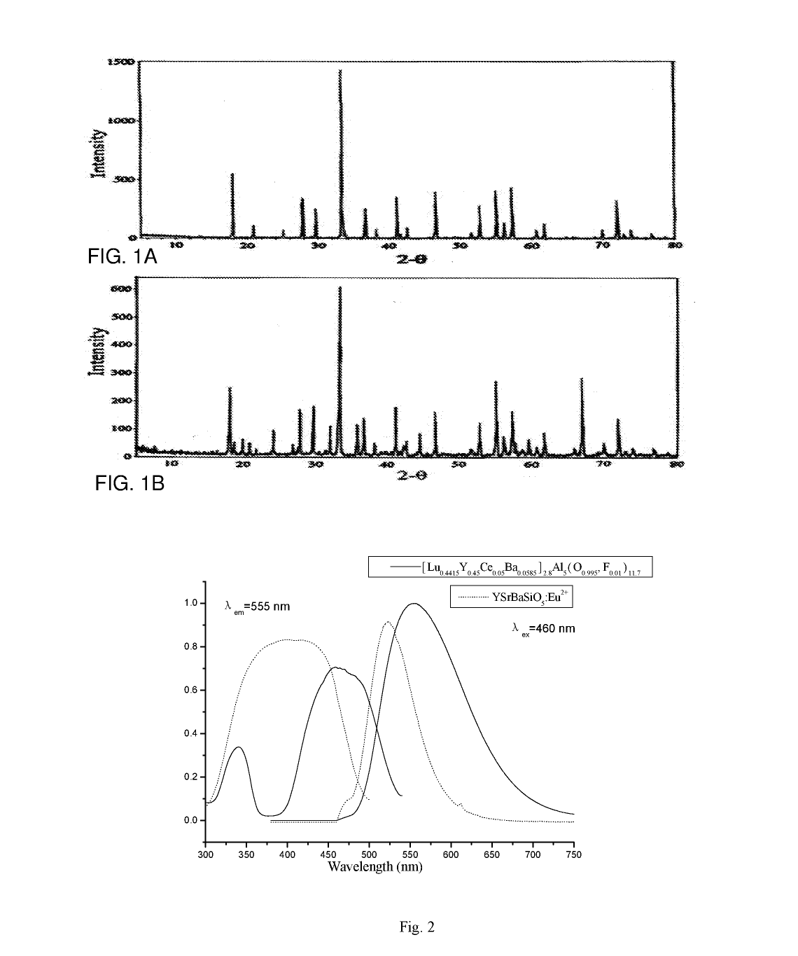

FIG. 1A and FIG. 1B show XRD spectra, respectively, of the Y₃Al₅O₁₂ standard powder diffraction card and the fluorescent material represented by the formula [Y_{0.7623}Gd_{0.17}Ce_{0.05}Ba_{0.01774}]_{2.884}Al₅(O_{0.9985},F_{0.003})_{11.826}. It shows that main diffraction peaks of FIG. 1B are basically in agreement with Y₃Al₅O₁₂ standard powder diffraction card (PDF#09-0310) (FIG. 1A) except for a few disordered peaks.

FIG. 2 shows the excitation and emission spectra for the fluorescent materials having a formula [Lu_{0.4415}Y_{0.45}Ce_{0.05}Ba_{0.0585}]_{2.8}Al₅(O_{0.995},F_{0.01})_{11.7} and silicate-based green-emitting phosphor powder with a formula YSrBaSiO₅:Eu²⁺, respectively, under monitoring of 555 nm and excitation of 460 nm blue LED. It can be seen from the figure that the emission spectrum of the aluminate phosphor powder (e.g., the fluorescent material of the present invention [Lu_{0.4415}Y_{0.45}Ce_{0.05}Ba_{0.0585}]_{2.8}Al₅(O_{0.995},F_{0.01})_{11.7}) covers a width of 520 nm to 610 nm and the emission peak is located near 556 nm, which is wider than the coverage of the silicate emission spectrum and the intensity is higher

FIG. 3 shows the emission spectrum of the fluorescent material having a formula [Y_{0.8829}Gd_{0.005}Ce_{0.05}Ba_{0.0621}]_{3.28}Al₅(O_{0.995},F_{0.01})_{12.42} excited at 460 nm blue LED. It can be seen from the figure that the emission spectrum covers a broadband from 520 nm to 610 nm and the emission peak is located at 546 nm.

FIG. 4 shows the effect of the variable ratios of Y to Lu on the emission spectra of phosphor powder, and the tested fluorescent materials having the following formulas respectively:

[Lu_{0.4812}Y_{0.45}Ce_{0.05}Ba_{0.0188}]_{3.35}Al₅(O_{0.9985},F_{0.003})_{12.525},

[Lu_{0.5812}Y_{0.35}Ce_{0.05}Ba_{0.0188}]_{3.35}Al₅(O_{0.9985},F_{0.003})_{12.525}, and

[Lu_{0.7312}Y_{0.2}Ce_{0.05}Ba_{0.0188}]_{3.35}Al₅(O_{0.9985},F_{0.003})_{12.525}.

It can be seen from the figure that the spectrum covers a broadband from 520 nm to 610 nm, moreover, with the decrease of the ratio of Y to Lu, the emission peaks blue shift and positions thereof are located at about 543 nm, 539 nm and 537 nm, respectively.

FIGS. 5 and 6 show the effect of the variable ratio of Y to Gd on excitation and emission spectra of phosphor powder and the tested fluorescent materials have the following formulas, respectively:

[Y_{0.7623}Gd_{0.17}Ce_{0.05}Ba_{0.01774}]_{2.884}Al₅(O_{0.9985},F_{0.003})_{11.826},

[Y_{0.6323}Gd_{0.29}Ce_{0.06}Ba_{0.01774}]_{2.884}Al₅(O_{0.9985},F_{0.003})_{11.826}, and

[Y_{0.3823}Gd_{0.55}Ce_{0.05}Ba_{0.01774}]_{2.884}Al₅(O_{0.9985},F_{0.003})_{11.826}.

As shown in FIG. 6, the spectrum covers a broadband from 520 to 610 nm, moreover, with the decrease of the ratio of Y to Gd, the emission peaks red shift and the positions thereof are located at 564 nm, 572 nm and 578 nm, respectively.

FIG. 7 shows the effect of the variable value of (3−δ) on the emission spectra of phosphor powder, and the tested fluorescent materials having the following formulas, respectively:

[Lu_{0.0995}Y_{0.7688}Gd_{0.07}Nd_{0.0005}Ce_{0.05}Ba_{0.01125}]_{2.5}(Al_{4.9}Ga_{0.1})(O_{0.999},F_{0.002})_{11.25}

[Lu_{0.0995}Y_{0.77}Gd_{0.07}Nd_{0.0005}Ce_{0.05}Ba_{0.01}]_{1.67}(Al_{4.9}Ga_{0.1})(O_{0.999},F_{0.002})_{10.005}.

It can be seen from the figure that the emission peaks blue shift with the decrease of the ratio of (3−δ), and the positions thereof are located at 562 nm and 555 nm, respectively.

FIG. 8 shows the effect of the variable ratio of Al to Ga on the emission spectra of phosphor powder, and the tested fluorescent materials having the following formulas, respectively:

[Y_{0.9262}Ce_{0.055}Ba_{0.0188}]_{3.35}Al_{4.5}Ga_{0.5}(O_{0.9985},F_{0.003})_{12.525},

[Y_{0.9262}Ce_{0.055}Ba_{0.0188}]_{3.35}Al_{4.0}Ga_{1.0}(O_{0.9985},F_{0.003})_{12.525},

[Y_{0.9262}Ce_{0.055}Ba_{0.0188}]_{3.35}Al_{3.5}Ga_{1.5}(O_{0.9985},F_{0.003})_{12.525},

[Y_{0.9262}Ce_{0.055}Ba_{0.0188}]_{3.35}Al_{3.0}Ga_{2.0}(O_{0.9985},F_{0.003})_{12.525}, and

[Y_{0.9262}Ce_{0.055}Ba_{0.0188}]_{3.35}Al_{2.79}Ga_{2.21}(O_{0.9985},F_{0.003})_{12.525}.

It can be seen from the figure that the emission peaks blue shift with the decrease of the ratio of Al to Ga, and the positions thereof are located at 549 nm, 540 nm, 535 nm, and 555 nm, respectively.

FIG. 9 shows the spectra for white LED photo-luminescent compositions, and the compositions are formed by the fluorescent material of the present invention having the formula (Lu_{0.4415}Y_{0.45}Ce_{0.05}Ba_{0.0585})_{2.8}Al₅ (O_{0.995},F_{0.01})_{11.7} with a red-emitting phosphor powder SrAlSiN₃:Eu²⁺ and (Sr,Ba)_{1.88}SiO₄:Eu²⁺, as well as by Y₃Al₅O₁₂:Ce³⁺ and SrAlSiN₃:Eu²⁺, respectively. The synthesized samples are tested in a blue light diode-based solid white light source, and the results show that the color rendering index (Ra) of the white LED formed by the invention and the nitride phosphor powder reaches 86.9, the corresponding color temperature (Tc) is 3495K, the coverage of the formed spectrum is border and the effect is better.

Thus, the results above indicated that, as varying the ratio of the stoichiometric index (3±δ) from 1.0 to 3.35, the optical characteristics of the samples do not change significantly. Wherein, as varying the ratio of the stoichiometric index (3±δ) from 1.0 to 2.884, the emission peaks slightly red shift, the corresponding color coordinates increase a little, and the color temperatures decrease faintly.

As varying the ratio of the stoichiometric index (3±δ) from 2.89 to 3.35, the emission peaks slightly blue shift, the corresponding color coordinates decrease a little, and the color temperatures increase faintly.

FIG. 2 demonstrates that the halogen co-activated aluminate fluorescent material of the present invention has a wider spectral coverage and a higher luminous intensity than the commonly used silicate luminescent material. FIG. 9 demonstrates that a white LED photo-luminescent composition having high luminous efficiency, high color rendering index, low color temperature and high stability can be obtained by combining the fluorescent material in the present invention and the nitride red-emitting phosphor powder.

It has been demonstrated that fluorescent materials having the general formula: [Lu_{1-a-c-d-2/3b}YₐZ(Ln−1)_{c}Σ(Ln−2)_{d}M_{b}]_{3±δ}[Al₁₋ₓGaₓ]₅(O_{1-1/2y}X_{y})_{12±1.5δ} can be synthesized, which materials may be combined with nitride or silicate red-emitting phosphor powder to produce a white LED photo-luminescent composition with high luminous efficiency, high color rendering index, low light decay, and low color temperature. This product has a very important practical significance.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

We claim:

1. A fluorescent material comprising a compound having a general formula I:
[Lu_{1-a-c-d-2/3b}YₐΣ(Ln−1)_{c}Σ(Ln−2)_{d}M_{b}]_{3±δ}[Al₁₋ₓGaₓ]₅(O_{1-1/2y}X_{y})_{12±1.5δ} (I)
in which:
M is at least one element selected from the group consisting of Ca, Mg, Ba, Sr, and Zn;
(1−a−c−d−2/3b+a+c+d)(3±δ)≠3, 0≦b≦0.2;
0.001≦a≦0.95;
0≦x≦0.5;
Σ(Ln−1) represents at least one element of La, Gd, Tb, Nd, Ho, and 0≦c≦0.9;
Σ(Ln−2) represents an activator and is at least one element selected from the group consisting of Ce, Pr, Dy, Eu, Tm, Er, Sm, Yb, and Sc, and 0.001≦d≦0.5;
X represents a co-activator, which is at least one element selected from F and Cl, and 0.001≦y≦0.2;
1−a−c−d≧0; and
0<δ≦1.5.

2. The fluorescent material according to claim 1, wherein said fluorescent material comprises a compound having a general formula I-1:
[Lu_{1-a-c-d-2/3b}YₐΣ(Ln−1)_{c}Σ(Ln−2)_{d}M_{b}]_{3-δ}[Al₁₋ₓGaₓ]₅(O_{1-1/2y}X_{y})_{12-1.5δ} (I-1)
in which Σ(Ln−2) represents at least one element of Ce and Pr.

3. The fluorescent material according to claim 1, wherein said fluorescent material comprising a compound having a general formula I-2:
[Lu_{1-a-c-d-2/3b}YₐΣ(Ln−1)_{c}Σ(Ln−2)_{d}M_{b}]_{3+δ}[Al₁₋ₓGaₓ]₅(O_{1-1/2y}X_{y})_{12+1.5δ} (I-2)
in which 0≦b<0.2.

4. The fluorescent material according to claim 1, wherein said fluorescent material is selected from the group consisting of following compounds:
[Lu_{0.4415}Y_{0.45}Ce_{0.05}Ba_{0.0585}]_{2.8}Al₅(O_{0.9957},F_{0.01})_{11.7};
[Y_{0.7623}Gd_{0.17}Ce_{0.05}Ba_{0.01774}]_{2.884}Al₅(O_{0.9985},F_{0.003})_{11.826};
[Y_{0.6323}Gd_{0.29}Ce_{0.06}Ba_{0.01774}]_{2.884}Al₅(O_{0.9985},F_{0.003})_{11.826};
[Y_{0.3823}Gd_{0.55}Ce_{0.05}Ba_{0.01774}]_{2.884}Al₅(O_{0.9985},F_{0.003})_{11.826};
[Lu_{0.0995}Y_{0.7688}Gd_{0.07}Nd_{0.0005}Ce_{0.05}Ba_{0.01125}]_{2.5}(Al_{4.9}Ga_{0.1})(O_{0.9997},F_{0.002})_{11.25}; and
[Lu_{0.0995}Y_{0.77}Gd_{0.07}Nd_{0.0005}Ce_{0.05}Ba_{0.01}]_{1.67}(Al_{4.9}Ga_{0.1})(O_{0.999},F_{0.002})_{10.005}.

5. The fluorescent material according to claim 1, wherein said fluorescent material is selected from the group consisting of following compounds:
[Y_{0.8829}Gd_{0.005}Ce_{0.05}Ba_{0.0621}]_{3.28}Al₅(O_{0.9957},F_{0.01})_{12.42};
[Lu_{0.4812}Y_{0.45}Ce_{0.05}Ba_{0.0188}]_{3.35}A1₅(O_{0.9985},F_{0.003})_{12.525};
[Lu_{0.5812}Y_{0.35}Ce_{0.05}Ba_{0.0188}]_{3.35}A1₅(O_{0.9985},F_{0.003})_{12.525};
[Lu_{0.7312}Y_{0.2}Ce_{0.05}Ba_{0.0188}]_{3.35}Al₅(O_{0.99857},F_{0.003})_{12.525};
[Y_{0.9262}Ce_{0.055}Ba_{0.0188}]_{3.35}Al_{4.5}Ga_{0.5}(O_{0.99857},F_{0.003})_{12.525};
[Y_{0.9262}Ce_{0.055}Ba_{0.0188}]_{3.35}Al_{4.0}Ga_{1.0}(O_{0.99857},F_{0.003})_{12.525};
[Y_{0.9262}Ce_{0.055}Ba_{0.0188}]_{3.35}Al_{3.5}Ga_{1.5}(O_{0.9985},F_{0.003})_{12.525};
[Y_{0.9262}Ce_{0.055}Ba_{0.0188}]_{3.35}Al_{3.0}Ga_{2.0}(O_{0.9985},F_{0.003})_{12.525}; and
[Y_{0.9262}Ce_{0.055}Ba_{0.0188}]_{3.35}Al_{2.79}Ga_{2.21}(O_{0.99857},F_{0.003})_{12.525}.

6. A method for preparing the fluorescent material according to claims 1 to 5, comprising:
mixing yttrium oxide, cerium oxide, aluminium oxide or aluminium hydroxide, gadolinium oxide, gallium oxide, lutetium oxide, neodymium oxide, aluminum fluoride, barium fluoride uniformly to form a mixture, in which the amounts of yttrium oxide, cerium oxide, aluminium oxide or aluminium hydroxide, gadolinium oxide, gallium oxide, lutetium oxide, neodymium oxide are weighed according to the molar ratios of the metal elements of the phosphor according to any one of claims 1 to 5, while aluminium oxide or aluminium hydroxide is added in an amount in excess of 2 percent by weight, barium fluoride is in an amount of from 2 to 4.5 percent by weight of all oxides, and aluminum fluoride is in an amount of less than 1 percent; and
roasting the mixture at a temperature of 1330° C. to 1580° C. under a reducing atmosphere of a nitrogen-hydrogen mixed gas or a carbon reducing atmosphere for 5 to 7 hours.

7. The method according to claim 6, wherein said roasting is undertaken at a temperature of 1426° C. for 5 hours under a carbon reducing atmosphere.

8. A photo-luminescent composition comprising:
fluorescent material according to claim 1, and
a red-emitting phosphor;
wherein the weight ratio of the fluorescent material and the red-emitting phosphor powder is from about 88%:12% to 92%:8%.

9. The photo-luminescent composition according to claim 8, wherein the weight ratio of the fluorescent material and the red-emitting phosphor is about 90%:10%.

10. The photo-luminescent composition according to claim 8, wherein said red-emitting phosphor is selected from the group consisting of nitrides and silicates.

11. The photo-luminescent composition according to claim 10, wherein the red-emitting phosphor is a nitride having a general formula of SrAlSiN₃:Eu²⁺.

12. The photo-luminescent composition according to claim 10, wherein the red-emitting phosphor is a silicate having a general formula of (Sr,Ba)_{1.88}SiO₄:Eu²⁺.

13. The photo-luminescent composition according to claim 11, wherein said fluorescent material is [Lu_{0.4415}Y_{0.45}Ce_{0.05}Ba_{0.0585}]_{2.8}Al₅(O_{0.995},F_{0.01})_{11.7}.
